(19) United States
(12) Patent Application Publication
(10) Pub. No.: US 2026/0246645 A1
(43) Pub. Date: Aug. 20, 2026

(54) METHOD FOR CHECKING A PARTIALLY DISTRIBUTED IDENTITY

(71) Applicant: IDEMIA PUBLIC SECURITY FRANCE, Courbevoie (FR)

(72) Inventors: Hervé CHABANNE, Courbevoie (FR); Alberto IBARRANDO, Courbevoie (FR)

(73) Assignee: IDEMIA PUBLIC SECURITY FRANCE, Courbevoie (FR)

(21) Appl. No.: 19/153,694

(22) PCT Filed: Feb. 16, 2024
(86) PCT No.: PCT/EP2024/054066

§ 371 Date: Aug. 5, 2025

(30) Foreign Application Priority Data
Mar. 1, 2023 (FR) FR2301900

(51) Int. Cl. H04L 9/32

(52) U.S. Cl. CPC H04L 9/3231

(57) ABSTRACT

The invention relates to a method comprising: calculating an encrypted version (cₛ) of a score representing a distance between an item of test biometric data (x) and an item of reference data (yᵤ; performing the following steps by means of a device with an index i=1, 2: performing a processing step for decrypting and masking the encrypted version (cₛ) of the score using a secondary decryption key ((sk)ᵢ) with an index i and a secondary mask ((r)ᵢ) with an index i, the processing step producing an item of data (ŝ) representing the score in decrypted form and masked by a primary mask (r) without having calculated the cleartext score, and generating a partial result (oᵢ) with an index i on the basis of the item of data (ŝ) and an unmasking item of data (kᵢ) with an index i; wherein the partial results (o₁, o₂) enable a result (o) indicating whether the item of test biometric data corresponds to the item of reference data to be calculated.

### FIELD OF THE INVENTION

The present disclosure relates to a method for checking an identity.

### PRIOR ART

A conventional method for checking whether an individual is enrolled in a database comprises the following steps. A test biometric datum relating to the individual to be checked is acquired. Next, a score representative of a distance between the test biometric datum and a reference biometric datum contained in the database is computed. This score is then compared with a threshold. A check result indicating whether or not the test biometric datum matches the reference biometric datum is obtained at the end of this comparison.

The document entitled “Colmade: Collaborative Masking in Auditable Decryption for BFV-based Homomorphic Encryption” has described a method that uses this general principle, but with the following characteristics. First, the Colmade method computes the score and compares it with a threshold in the encrypted domain. Secondly, the Colmade method comprises centralized steps, and steps distributed over multiple entities: these entities perform parallel computations producing partial results, these partial results then having to be recombined in order to arrive at the check result.

However, the execution time of the Colmade method is long.

### SUMMARY OF THE INVENTION

An aim of the invention is to check whether an individual is enrolled in a database without requiring excessive execution time and in a secure manner.

This aim is achieved by a method comprising the following steps:
computing a cipher of a score representing a distance between a test biometric datum relating to an individual and a reference biometric datum, the cipher of the score being previously computed from the test biometric datum and a cipher of the reference biometric datum, the cipher of the reference biometric datum resulting from an encryption of the reference biometric datum using a primary encryption key,
when i is equal to 1 and 2, performing the following steps by way of a device of index i:
   applying decryption and masking processing to the cipher of the score using a secondary decryption key of index i and a secondary mask of index i, the decryption and masking processing producing a datum representing the score in a form that is decrypted and masked by a primary mask, without having computed the score in plaintext,
   generating a partial result of index i from the datum and an unmasking datum of index i associated with the secondary mask of index i,
wherein:
   the devices of respective indices 1 and 2 are distinct,
   the secondary decryption keys of respective indices 1 and 2 stem from a primary decryption key associated with the encryption key,
   the secondary masks of respective indices 1 and 2 stem from the primary mask.

In the proposed method, the step of computing the cipher of the score constitutes a centralized step that is much faster to perform than the centralized step carried out in the Colmade method. The inventors have been able to observe that this centralized step in combination with the processing distributed over at least one pair of participating devices can be used to obtain a check result more quickly than with the Colmade method, with equal computing resources. In particular, the masking carried out provides security because the score in plaintext is never computed.

Another advantage of the proposed method is that it can be performed in a system where the reference biometric data are stored in a single database. This is an advantage over methods that require the joint use of multiple different databases.

The proposed method may also comprise the following features, taken alone or in combination whenever possible.

Preferably, the decryption and masking processing performed by the device of index i comprises the following steps:
computing an intermediate datum of index i from the following data:
   a first part of the cipher of the score,
   the secondary decryption key of index i,
   the secondary mask of index i, and
   a random quantity generated by the device of index i,
receiving an intermediate datum of index j sent by the device of index j=i,
computing the datum representing the score in a form that is decrypted using the secondary decryption key [symbol] sk [symbol] ᵢ of index i, then masked by the mask, from the following data:
   the intermediate data of respective indices 1 and 2,
   a second part of the cipher of the score.

Preferably, the intermediate datum [symbol] c_{ŝ}_{_{b}} [symbol] ᵢ of index i is computed as follows:

$$〈 {c}_{{\hat{s}}_{b}} {〉}_{i} = {c}_{{s}_{b}} 〈 sk {〉}_{i} + 〈 r {〉}_{i} + {e}_{i}$$

wherein.
   cₛ_{_{b}} is the first part of the cipher of the score,
   [symbol] sk [symbol] ᵢ is the secondary decryption key of index i,
   [symbol] r [symbol] ᵢ is the secondary mask of index i,
   eᵢ is the random quantity generated by the device of index i.

Preferably, the datum representing the score in a form decrypted using the secondary decryption key [symbol] sk [symbol] ᵢ of index i, then masked using the primary mask, is computed as follows:

$${\hat{s} = [ ⌊ {\frac{t}{q} [ {c}_{{s}_{a}} + 〈 {c}_{{\hat{s}}_{b}} {〉}_{1} + 〈 {c}_{{\hat{s}}_{b}} {〉}_{2} ]}_{q} ⌉ ]}_{t}$$

wherein
   [symbol] c_{ŝ}_{_{b}} [symbol] ₁ is the intermediate datum of index 1,
   [symbol] c_{ŝ}_{_{b}} [symbol] ₂ is the intermediate datum of index 2,
   cₐ is the second part of the cipher of the score,
   t and q are two integers constituting parameters of a Brakerski/Fan-Vercauteren encryption scheme,
   └ . . . ┘ signifies the operator for rounding to the nearest integer,
   └ . . . ┘_{q} signifies the modulo q operator,
   └ . . . ┘ₜ signifies the modulo t operator.

Preferably, the check result is equal to the sum of the partial results of respective indices 1 and 2.

Preferably, at least one of the following data is a single-use datum for the test biometric datum, or even for the cipher of the score:
the secondary mask of index i,
the unmasking datum of index i,
the secondary decryption key of index i.

Preferably, the computation of the cipher of the score is a linear or polynomial computation.

Preferably,
the computation of the cipher is performed by a server distinct from the devices of indices 1 and 2, and/or
the output result is computed from the partial results of respective indices 1 and 2 by an output device distinct from the devices of indices 1 and 2.

Also proposed is a computer program product comprising program code instructions for carrying out the steps of the proposed method when this program is executed by a device or a set of devices. Also proposed is a computer-readable memory storing instructions that are executable by a device for carrying out the steps of the proposed method.

Also proposed is a system comprising:
a server configured to compute a cipher of a score representing a distance between a test biometric datum relating to an individual and a reference biometric datum, the cipher of the score being previously computed from the test biometric datum and a cipher of the reference biometric datum, the cipher of the reference biometric datum resulting from an encryption of the reference biometric datum using a primary encryption key,
two devices of respective indices 1 and 2, wherein when i is equal to 1 and 2, the device of index i is configured to:
   apply decryption and masking processing to the cipher of the score using a secondary decryption key of index i and a secondary mask of index i, the decryption and masking processing producing a datum representing the score in a form that is decrypted and masked by a primary mask, without having computed the score in plaintext,
   generate a partial result of index i from the datum and an unmasking datum of index i associated with the secondary mask of index i,
wherein:
   the secondary decryption keys of respective indices 1 and 2 stem from a primary decryption key associated with the encryption key,
   the secondary masks of respective indices 1 and 2 stem from the primary mask,
   the partial results of respective indices 1 and 2 can be used to compute a check result indicating whether or not the test biometric datum matches the reference biometric datum.

### DESCRIPTION OF THE FIGURES

Further features, aims and advantages of the invention will become apparent from the following description, which is purely illustrative and non-limiting, and which should be read with reference to the appended drawings, in which:

FIG. 1 and FIG. 2 schematically illustrate various devices forming part of a system according to one embodiment, able to be used to check the identity of individuals.

FIG. 3 is a flowchart of steps of a method for checking an identity according to one embodiment.

In all of the figures, elements that are similar have been designated by identical references.

### DETAILED DESCRIPTION OF THE INVENTION

### System for Checking the Identity of an Individual

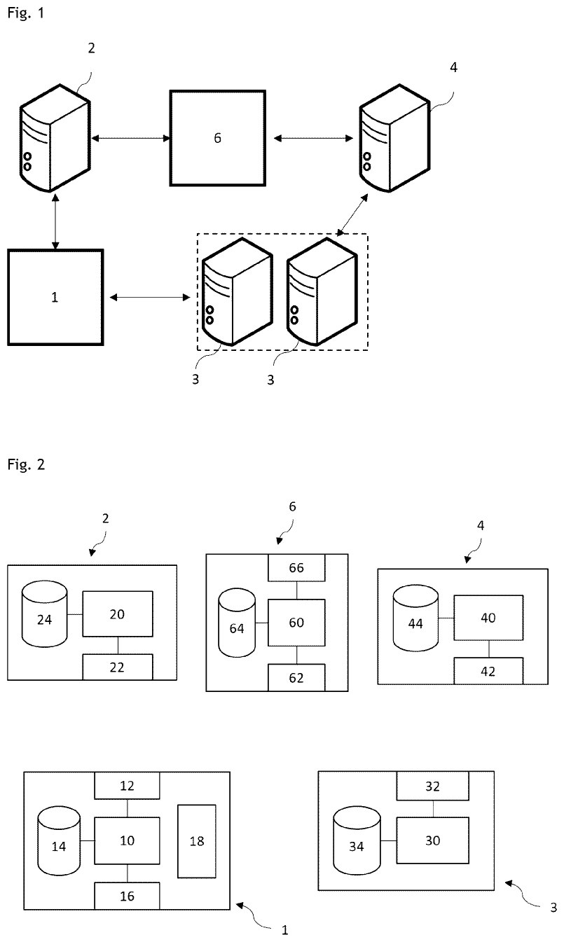

Referring to FIG. 1 and FIG. 2, a system comprises a control device 1, a storage server 2, at least one pair of participating devices 3, a trusted server 4 and an enrollment device 6.

The control device 1 comprises a processor 10, a communication interface 12 for communicating with the storage server 2 and each participating device, a memory 14 and a biometric sensor 16.

The processor 10 is configured to perform some steps of a method that will be described later. The processor may have any structure. The processor comprises one or more cores, each core being configured to execute the code instructions of a program so as to perform the aforementioned steps.

The communication interface 12 is for example of wireless radio type, and uses any communication protocol (Wi-Fi, Bluetooth, etc.).

The memory 14 is designed to store data manipulated or produced by the processor. The memory 14 is of any type. Conventionally, the memory comprises a volatile memory for storing data temporarily, and a non-volatile memory for storing data persistently, that is to say in a manner that preserves the data when the non-volatile memory is switched off.

The biometric sensor 16 is configured to acquire biometric data relating to individuals. For example, the biometric sensor comprises a camera configured to acquire images showing the face of an individual, and to extract biometric data from such images. As an alternative or in addition, the biometric sensor comprises a fingerprint sensor and/or an iris sensor.

In one embodiment, the control device 1 additionally comprises a gate 18 that can be closed in order to prevent an individual from accessing a secure area, and can be opened in order to allow such access. The processor 10 is in this case configured to control the opening and closing of the gate 18. For example, the control device 1 is located in an airport, and the secure area is a boarding area; in this specific application, the individuals wishing to access the boarding area are the passengers on a flight, whose identity needs to be checked before boarding.

The storage server 2 comprises a processor 20, a communication interface 22 for communicating with the control device 1, and a memory 24. The information provided above with regard to the processor 10 and the communication interface 12 can also be applied to the processor 20 and to the communication interface 22.

The memory 24 stores a biometric database containing confidentiality-protected biometric data. Biometric data relating to previously enrolled individuals are referenced in the database. The biometric data of an enrolled individual are not in plaintext in the database, but are, by contrast, confidentiality-protected, that is to say have an encrypted form, by virtue of an encryption that will be described hereinafter.

Each participating device 3 comprises a processor 30, a communication interface 32 for communicating with the control device 1 and/or the other participating devices 3, and a memory 34. The information provided above with regard to the processor 10 and the communication interface 12 can also be applied to the processor 30 and to the communication interface 32. The communications between the interfaces 12, 22 and the communications between the interfaces 12, 32 may use identical or else different protocols.

The participating devices 3 are distinct from one another. Hereinafter, a detailed description will be given of an embodiment in which the participating devices 3 are distinct from the control device 1, from the storage server 2, from the enrollment device 4 and from the enrollment device 6, as shown in FIG. 1. However, in other embodiments, it may be envisaged that the control device 1, the storage server 2, the enrollment device 4 and/or the enrollment device 6 constitute(s) one of the participating devices 3.

The function of the trusted server 4 is to generate cryptographic keys, some of which are used by other components of the system. The trusted server 4 comprises a processor 40, a communication interface 42 for communicating with the enrollment device 6 and with each participating device 3, and a memory 44. The information provided above with regard to the processor 10, the communication interface 12 and the memory 14 can also be applied to the processor 40, the communication interface 42 and the memory 44.

The enrolment device 6 comprises a processor 60, a communication interface 62 for communicating with the trusted server 4 and with the storage server 2, a memory 64 and a biometric sensor 66. The information provided above with regard to the processor 10, the communication interface 12, the memory 14 and the biometric sensor 16 can also be applied to the processor 60, the interface 62, the memory 64 and the biometric sensor 66. Hereinafter, a detailed description will be given of an embodiment in which the enrollment device 6 is distinct from the control device 1. However, in other embodiments, the control device 1 could be used as an enrollment device.

### Key Generation

The following steps are performed preliminarily within the system.

The processor 40 of the trusted server 4 generates an encryption key pk and an associated decryption key sk, the two keys forming a pair of cryptographic keys, typically a pair of asymmetric keys. The keys are, for example, randomly generated.

The keys pk, sk are stored in the memory 44.

The trusted server 4 sends the enrollment device the encryption key pk, which is therefore a public key. In contrast, the decryption key sk is a private key specific to the trusted server 4, and which is therefore not communicated outside the trusted server 4.

### Enrollment

It is assumed that a reference individual to be enrolled arrives in the vicinity of the enrollment device 6. In practice, the reference individual may be an individual who has obtained the right to access the secure area discussed above. When the control device 1 is placed at an airport, the secure area may give access to an aircraft, in which case the right to access the secure area is conferred by a ticket assigned to the reference individual.

The biometric sensor 66 of the enrollment device 6 acquires a reference biometric datum yᵤ relating to the reference individual.

The processor 60 encrypts the reference biometric datum yᵤ using the encryption key pk, so as to obtain a cipher c_{y}_{ᵤ} of the biometric datum yᵤ. Using BFV.encr( ) to denote the encryption function used in this step gives:

$${c}_{{y}_{u}} = BFV \cdot encr ( {y}_{u} , pk )$$

In particular, encryption according to the Brakerski/Fan-Vercauteren (BFV) scheme can be used in this step.

The cipher c_{y}_{ᵤ} is transmitted by the enrollment device 6 to the storage server 2 via the communication interface 62.

The storage server receives the cipher c_{y}_{ᵤ} via its communication interface 22, and adds it to the database contained in its memory 24. The reference individual is then enrolled.

The above steps are repeated by the enrollment device 6 for multiple reference individuals to be enrolled, whereby the database of data contained in the memory 24 stores a plurality of ciphers relating to different reference individuals. Each time, the same encryption key pk is used by the processor 60.

### Identity Check

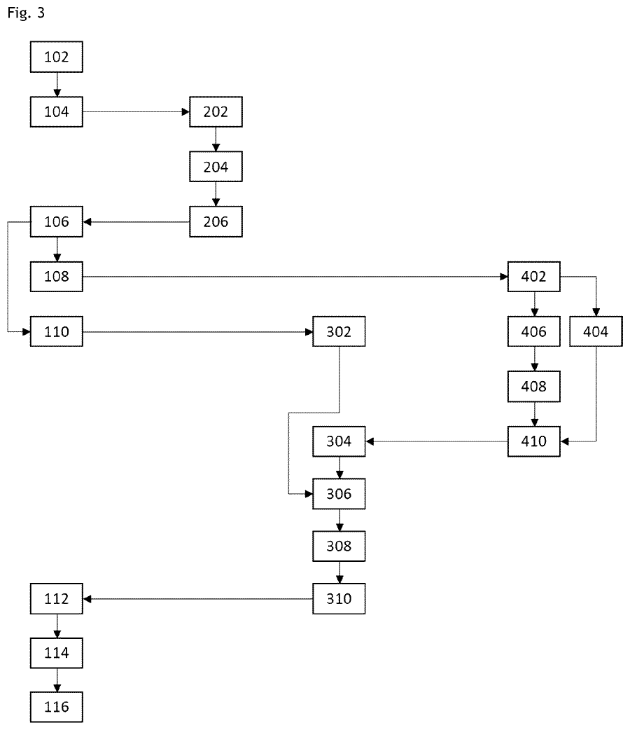

Referring to FIG. 3, a method carried out by means of the system comprises the following steps. When it is mentioned hereinafter that the control device 1, the server 2, a participating device 3 or the trusted server 4 performs processing, it will be understood that this processing is more specifically performed by the corresponding processor 10, 20, 30, 40.

It is assumed that an individual whose identity needs to be checked arrives in the vicinity of the control device 1. For example, the individual to be checked arrives at a boarding gate of an airport where the control device 1 has been installed, wanting to board an aircraft.

In a step 102, the biometric sensor 16 acquires a biometric datum x relating to the individual to be checked. Hereinafter, this biometric datum x is called the “test biometric datum” in order to distinguish it from the reference biometric data discussed above, and the respective ciphers of which are stored by the storage server 2.

In a step 104, the control device 1 sends the test biometric datum x to the server 2 via the communication interface 12.

In a step 202, the server 2 receives the test biometric datum via the communication interface 22.

In a step 204, the server 2 applies processing BFV.dist( ) taking as input the test biometric datum x and the cipher c_{y}_{ᵤ}, the processing producing the cipher cₛ of a score s, this score s representing a distance between the test biometric datum x and the reference biometric datum yᵤ:

$${c}_{s} = BFV \cdot dist ( x , {c}_{{y}_{u}} )$$

The computation of the cipher cₛ is carried out in this step in the encrypted domain. In other words, this step does not comprise computing the score s in plaintext. Those skilled in the art can use homomorphic encryption methods known from the prior art.

The function BFV.dist( ) is preferably a linear or polynomial function.

By way of example, the distance represented by the score is a scalar product between the test biometric datum x and the reference biometric datum yᵤ. Thus, the cipher cₛ is the cipher of such a scalar product.

Hereinafter, consideration will be given to an embodiment in which the cipher cₛ of the score is in the form of a data pair cₛ_{ₐ}, cₛ_{_{b}}. These two data constitute two different portions of the cipher.

In a step 206, the storage server sends the cipher cₛ to the device 1 in response to the test biometric datum x.

In a step 106, the control device 1 receives the cipher cₛ.

In a step 108, the control device 1 sends the trusted server 4 a request associated with the cipher cₛ.

In a step 110, the control device 1 sends the cipher cₛ to each of the participating devices 3. Steps 108 and 110 can be carried out in any order or can be simultaneous. In a step 402, the trusted server 4 receives the request sent during step 108.

In a step 404, the trusted server 4 generates two secondary decryption keys [symbol] sk [symbol] ₁, [symbol] sk [symbol] ₂ stemming from the decryption key sk.

Furthermore, in a step 406, the trusted server 4 generates a primary mask r. The primary mask r is generated by a function FSS.Setup( ). The function FSS.Setup( ) may, for example, be the function Funshade.Setup( ) described in the document “Funshade: Functional Secret Sharing for Two-Party Secure Thresholded Distance Evaluation”.

In a step 408, the server generates:
two secondary masks [symbol] r [symbol] ₁, [symbol] r [symbol] ₂ stemming from the primary mask r, and
two unmasking data k₁, k₂ which are associated with them.

Steps 404 and 406 can be performed in any order. In particular, step 404 can be carried out before, during or after steps 406 and 408.

In a step 410 performed when i is equal to 1 and 2, the trusted server 4 transmits to the participating device 3 of index i:
the secondary decryption key [symbol] sk [symbol] ᵢ of index i,
the secondary mask [symbol] r [symbol] ᵢ of index i, and
the unmasking datum kᵢ of index i that is associated with the secondary mask [symbol] r [symbol] ᵢ of index i.

On the other hand, any datum of index 1 generated by the trusted server 4 in steps 402 and 404 is not sent to the participating device 3 of index 2, and vice versa.

When i is equal to 1 and 2, the participating device 3 of index i performs the following steps.

In a step 302, the participating device 3 of index i receives the cipher cₛ.

In a step 304, the participating device 3 of index i receives:
the secondary decryption key [symbol] sk [symbol] ᵢ of index i,
the secondary mask [symbol] r [symbol] ᵢ of index i, and
the unmasking datum kᵢ of index i, which is associated with the secondary mask [symbol] r [symbol] ᵢ of index i.

Steps 302 and 304 can occur in any order, depending on how the control device 1 operates.

In a step 306, the participating device 3 of index i applies decryption and masking processing ColMaskDecr( ) to the cipher cₛ of the score. This processing produces a datum s representing the score in a form that is decrypted using the primary decryption key, then masked using the mask r. We can thus write:

$$\hat{s} = C o l M a s k Decr ( {c}_{s} , 〈 sk {〉}_{i} , 〈 r {〉}_{i} )$$

If we decrypt the cipher cₛ using the primary decryption key sk, we would obtain the score s in plaintext. If we then applied masking to the score s in plaintext using the primary mask r, we would obtain the datum s.

However, the decryption and masking processing ColMaskDecr( ) does not work according to this sequence of operations. The decryption and masking processing ColMaskDecr( ) has the specific property of arriving at the datum s without performing intermediate computation of the score s in plaintext.

An embodiment of the decryption and masking processing ColMaskDecr( ) in which this property is obtained will now be described in detail. In this embodiment, the cipher cₛ of the score is in the form of a data pair cₛ_{ₐ}, cₛ_{_{b}}. These two data constitute two different portions of the cipher cₛ.

The participating device 3 of index i computes an intermediate datum [symbol] c_{ŝ}_{_{b}} [symbol] ᵢ of index i from the following data: the part cₛ) of the cipher cₛ, the secondary decryption key [symbol] (sk [symbol] ᵢ of index i, the mask [symbol] r [symbol] ᵢ of index i, and a random quantity eᵢ generated by the device of index i.

This computation can be as follows:

$$〈 {c}_{{\hat{s}}_{b}} {〉}_{i} = {c}_{{s}_{b}} 〈 sk {〉}_{i} , 〈 r {〉}_{i} + {e}_{i}$$

The participating device 3 of index i sends the intermediate datum [symbol] c_{ŝ}_{_{b}} [symbol] ᵢ of index i to the other participating device 3 of index j=i. Furthermore, the participating device 3 of index i receives an intermediate datum [symbol] c_{ŝ}_{_{b}} [symbol] ⱼ of index j=i produced by the other participating device of index j=i.

Ultimately, two intermediate data [symbol] c_{ŝ}_{_{b}} [symbol] ₁, [symbol] c_{ŝ}_{_{b}} [symbol] ₂ are interchanged between the two participating devices 3 of respective indices 1 and 2.

The participating device 3 of index i computes the datum s from the intermediate data [symbol] c_{ŝ}_{_{b}} [symbol] ₁, [symbol] c_{ŝ}_{_{b}} [symbol] ₂, and from the part cₛ_{ₐ} of the cipher (cₛ) of the score. This computation can be performed as follows:

$${\hat{s} = [ ⌊ {\frac{t}{q} [ {c}_{{s}_{a}} + 〈 {c}_{{\hat{s}}_{b}} {〉}_{1} + 〈 {c}_{{\hat{s}}_{b}} {〉}_{2} ]}_{q} ⌉ ]}_{t}$$

wherein
[symbol] c_{ŝ}_{_{b}} [symbol] ₁ is the intermediate datum of index 1,
[symbol] c_{ŝ}_{_{b}} [symbol] ₂ is the intermediate datum of index 2,
cₛ_{ₐ} is the second part of the cipher (cₛ) of the score,
t and q are two integers constituting parameters of a Brakerski/Fan-Vercauteren encryption scheme,
└ . . . ┘ signifies the operator for rounding to the nearest integer,
└ . . . ┘_{q} signifies the modulo q operator,
└ . . . ┘ₜ signifies the modulo t operator.

In this embodiment, it holds that:

$$\hat{s} ≡ s + r$$

In this equation, the sign ≡ represents an equality. Thus, the datum ŝ turns out to be equal to the sum of the score s in plaintext and the primary mask r. However, it is not this sum computation that is performed by the participating device 3 of index i. Besides, the participating device 3 of index i has no knowledge of the primary mask r, only of the secondary mask [symbol] r [symbol] ᵢ that stemmed therefrom.

In a step 308, the participating device 3 of index i computes a partial result oᵢ of index i from the datum and the unmasking datum kᵢ of index i:

$${o}_{i} = FSS \cdot eval ( \hat{s} , {k}_{i} )$$

In a step 310, the participating device 3 of index i sends the partial result oᵢ to the control device 1.

The processing performed by the participating device 3 of index i is finished.

As indicated above, the processing constituted by steps 302 to 310 is performed twice: once by the participating device of index 1 and once by the participating device of index 2. Thus, two partial results o₁, o₂ are generated.

The pair of partial results o₁, o₂ has the property of being able to be used to compute a check result o indicating whether or not the test biometric datum x matches the reference biometric datum yᵤ. On the other hand, it is not possible to compute this check result on the basis of just one of the two partial results o₁, o₂.

In a step 112, the control device 1 receives the two partial results o₁, o₂ respectively generated and sent by the two participating devices 3.

In a step 114, the control device 1 computes the check result o from the two partial results o₁, o₂ received. As indicated above, the check result indicates whether or not the test biometric datum matches the reference biometric datum.

In one embodiment, the check result o is obtained by summing the partial results, as follows:

$$o = {o}_{1} + {o}_{2}$$

Ultimately, the cryptographic processing jointly carried out by the two participating devices 3 and the step of computing the check result o represent a comparison between a threshold and the distance between the test biometric datum and the reference biometric datum. The threshold is defined in the function FSS.Setup( ) used to generate the primary mask r, the secondary decryption keys and the unmasking data (the threshold is encoded by these data, as it were).

In practice, the check result o may be a Boolean.

If the check result o indicates that the test biometric datum matches the reference biometric datum, then the individual to which the test biometric datum x relates is considered to have previously been enrolled with the server 2. Under these conditions, the processor 10 can open the gate 18 in a step 116 in order to allow the individual to access a secure area.

If the check result indicates that the test biometric datum does not match the reference biometric datum, then the checked individual is considered not to be the reference individual to which the reference biometric datum yᵤ relates.

The preceding steps (in particular those performed by the participating devices 3) can be performed U times for different ciphers stored by the storage server 2, and relating to different reference biometric data y₁ . . . yᵤ . . . y_{U}. These U performances may be sequential. As a variant, it is therefore possible to start U processes in parallel, each performing steps 202 to 116 described above, and to aggregate the final results in step 308 (thus oᵢ=Σᵤ o_{i,u}), or in step 114 (thus o=Σᵢ Σᵤ o_{i,u}).

The method described above may be subject to other variants.

It will be noted that in the method embodiment shown in FIG. 3 and discussed hitherto, new masks, new unmasking data and new secondary decryption keys are generated in steps 404 and 408 each time a score cipher is generated when step 204 is performed. Thus, when i is equal to 1 and 2, the secondary mask of index i, the associated unmasking datum of index i and the associated secondary decryption key of index i constitute single-use data for a particular cipher computed when a step 204 is performed. This embodiment is particularly robust against replay attacks.

In another embodiment, it could be envisaged that the data generated in steps 404 and 408 are single-use data for a test biometric datum x, this implying that these data are reused multiple times for different reference users referenced in the database of the storage server 2, during an identity check on the individual to which x relates. In this other embodiment, the control device 1 may request generation of new single-use data from the trusted server 4 each time a new test biometric datum x is acquired.

Although this is advantageous in terms of security, the secondary mask of index i, the associated unmasking datum of index i and the associated secondary decryption key of index i may not be single-use data.

Moreover, it has been assumed up to now that the data provided by the server 4 (secondary keys, masks, unmasking data) are generated after a biometric datum x is received. This is not mandatory, however. As a variant, these data can be generated during the preliminary phase during which the keys pk and sk are generated, and can be stored in the respective memories of the participating devices 3 in advance, and therefore before the biometric datum x is acquired. Thus, all or some of steps 404, 406, 408, 410 and 304 can take place before step 102 (in this case, step 108 is not performed, nor is step 402).

In one particularly advantageous embodiment, only one pair of participating devices 3 of respective indices 1 and 2 is used. The inventors were able to observe that this embodiment is easy to implement, while being reasonably fast and secure. However, it is also possible to use multiple pairs of participating devices performing the method described above. The [symbol] c_{ŝ}_{_{b}} [symbol] ⱼ of the participating devices 3 of a pair are interchanged only between the participating devices 3 of said pair. Moreover, for each pair of participating devices 3, the sum of the partial results of the pair is equal to the check result o. On the other hand, the trusted server 4 can provide different pairs of participants with different secondary keys and masking/unmasking data. The benefit of using multiple pairs of devices 3 is that of providing redundancy so as to ensure that there has not been a computing error by a pair, for example in the event of attacks.

One particular application of the identity checking method, in which the result of the check is a condition for accessing a secure area, has been discussed above. However, it will be understood that the described method may be used for other applications.

1. A method comprising:
computing cipher (cₛ) of a score representing a distance between a test biometric datum (x) relating to an individual and a reference biometric datum (yᵤ), the cipher (cₛ) of the score being previously computed from the test biometric datum and a cipher (c_{y}_{ᵤ}) of the reference biometric datum, the cipher of the reference biometric datum resulting from an encryption of the reference biometric datum (yᵤ) using a primary encryption key (pk),
when i is equal to 1 and 2, performing the following steps by way of a device of index i:
applying decryption and masking processing to the cipher (cₛ) of the score using a secondary decryption key ( [symbol] sk [symbol] ᵢ) of index i and a secondary mask ( [symbol] r [symbol] ᵢ) of index i, the decryption and masking processing producing a datum (ŝ) representing the score in a form that is decrypted and masked by a primary mask (r), without having computed the score in plaintext,
generating a partial result (oᵢ) of index i from the datum (ŝ) and an unmasking datum (kᵢ) of index i associated with the secondary mask ( [symbol] r [symbol] ᵢ) of index i,
wherein:
the devices of respective indices 1 and 2 are distinct,
the secondary decryption keys ( [symbol] sk [symbol] ₁, [symbol] sk [symbol] ₂) of respective indices 1 and 2 stem from a primary decryption key (sk) associated with the encryption key (pk),
the secondary masks ( [symbol] r [symbol] ₁, [symbol] r [symbol] ₂) of respective indices 1 and 2 stem from the primary mask (r),
the partial results (o₁, o₂) of respective indices 1 and 2 can be used to compute a check result (o) indicating whether or not the test biometric datum matches the reference biometric datum.

2. The method as claimed in claim 1, wherein the decryption and masking processing performed by the device of index i comprises the following steps:
computing an intermediate datum ( [symbol] c_{ŝ}_{_{b}} [symbol] ᵢ) of index i from the following data:
a first part (cₛ_{_{b}}) of the cipher (cₛ) of the score,
the secondary decryption key ( [symbol] sk [symbol] ᵢ) of index i,
the secondary mask ( [symbol] r [symbol] ᵢ) of index i, and
a random quantity (eᵢ) generated by the device of index i,
receiving an intermediate datum ( [symbol] c_{ŝ}_{_{b}} [symbol] ⱼ) of index j sent by the device of index j≠i,
computing the datum (ŝ) representing the score in a form that is decrypted using the secondary decryption key [symbol] sk [symbol] ᵢ of index i, then masked by the mask (r), from the following data:
the intermediate data ( [symbol] c_{ŝ}_{_{b}} [symbol] ₁, ( [symbol] c_{ŝ}_{_{b}} [symbol] ₂) of respective indices 1 and 2,
a second part (cₛ_{ₐ}) of the cipher (cₛ) of the score.

3. The method as claimed in claim 2, wherein the intermediate datum [symbol] c_{ŝ}_{_{b}} [symbol] ᵢ of index i is computed as follows:
$$〈 {c}_{{\hat{s}}_{b}} {〉}_{i} = {c}_{{s}_{b}} 〈 sk {〉}_{i} , 〈 r {〉}_{i} + {e}_{i}$$
wherein
cₛ_{_{b}} is the first part of the cipher (cₛ) of the score, [symbol]
sk [symbol] ᵢ is the secondary decryption key of index i, [symbol]
r [symbol] ᵢ is the secondary mask of index i,
eᵢ is the random quantity generated by the device of index i.

4. The method as claimed in claim 2, wherein the datum (ŝ) representing the score in a form decrypted using the secondary decryption key [symbol] sk [symbol] ᵢ of index i, then masked using the primary mask (r), is computed as follows:
$${\hat{s} = [ ⌊ {\frac{t}{q} [ {c}_{{s}_{a}} + 〈 {c}_{{\hat{s}}_{b}} {〉}_{1} + 〈 {c}_{{\hat{s}}_{b}} {〉}_{2} ]}_{q} ⌉ ]}_{t}$$
wherein [symbol]
c_{ŝ}_{_{b}} [symbol] ₁ is the intermediate datum of index 1, [symbol]
c_{ŝ}_{_{b}} [symbol] ₂ is the intermediate datum of index 2,
cₐ is the second part of the cipher (cₛ) of the score,
t and q are two integers constituting parameters of a Brakerski/Fan-Vercauteren encryption scheme,
└ . . . ┘ signifies the operator for rounding to the nearest integer,
└ . . . ┘_{q} signifies the modulo q operator,
└ . . . ┘ₜ signifies the modulo t operator.

5. The method as claimed in claim 1, wherein the check result (o) is equal to the sum of the partial results (o₁, o₂) of respective indices 1 and 2.

6. The method as claimed in claim 1, wherein at least one of the following data is a single-use datum for the test biometric datum (x), or even for the cipher (cₛ) of the score:
the secondary mask of index i,
the unmasking datum of index i,
the secondary decryption key of index i.

7. The method as claimed in claim 1, wherein the computation of the cipher (cₛ) of the score is a linear or polynomial computation.

8. The method as claimed in claim 1, wherein
the computation of the cipher (cₛ) is performed by a server distinct from the devices of indices 1 and 2, and/or
the output result is computed from the partial results (o₁, o₂) of respective indices 1 and 2 by an output device distinct from the devices of indices 1 and 2.

9. A computer program product comprising program code instructions for carrying out the steps of the method as claimed in claim 1 when this program is executed by a system comprising the devices of respective indices 1 and 2.

10. A computer-readable memory storing instructions that are executable by a device for carrying out the steps of the method as claimed in claim 1.

11. A system comprising:
a server configured to compute a cipher (cₛ) of a score representing a distance between a test biometric datum (x) relating to an individual and a reference biometric datum (yᵤ), the cipher (cₛ) of the score being previously computed from the test biometric datum and a cipher (c_{y}_{ᵤ}) of the reference biometric datum, the cipher of the reference biometric datum resulting from an encryption of the reference biometric datum (yᵤ) using a primary encryption key (pk),
two devices of respective indices 1 and 2, wherein when i is equal to 1 and 2, the device of index i is configured to:
apply decryption and masking processing to the cipher (cₛ) of the score using a secondary decryption key ( [symbol] sk [symbol] ᵢ) of index i and a secondary mask ( [symbol] r [symbol] ᵢ) of index i, the decryption and masking processing producing a datum (ŝ) representing the score in a form that is decrypted and masked by a primary mask (r), without having computed the score in plaintext,
generate a partial result (oᵢ) of index i from the datum (ŝ) and an unmasking datum (kᵢ) of index i associated with the secondary mask ( [symbol] r [symbol] ᵢ) of index i,
wherein:
the secondary decryption keys ( [symbol] sk [symbol] ₁, [symbol] sk [symbol] ₂) of respective indices 1 and 2 stem from a primary decryption key (sk) associated with the encryption key (pk),
the secondary masks ( [symbol] r [symbol] ₁, [symbol] r [symbol] ₂) of respective indices 1 and 2 stem from the primary mask (r),
the partial results (o₁, o₂) of respective indices 1 and 2 can be used to compute a check result (o) indicating whether or not the test biometric datum matches the reference biometric datum.
